(19) United States
(12) Patent Application Publication
(10) Pub. No.: US 2025/0065206 A1
(43) Pub. Date: Feb. 27, 2025

(54) Feedback System for Wearable Devices for Detecting and Improving American Football Spin Moves

(71) Applicant: Samuel Yong-En Jin, Palo Alto, CA (US)

(72) Inventor: Samuel Yong-En Jin, Palo Alto, CA (US)

(21) Appl. No.: 18/452,562

(22) Filed: Aug. 21, 2023

(51) Int. Cl. A63B 69/00; A63B 24/00; A63B 71/06

(52) U.S. Cl. CPC A63B 69/002; A63B 24/0006; A63B 71/0622; A63B 2220/803; A63B 2220/836; A63B 2243/007

(57) ABSTRACT

The invention introduces a feedback system tailored for wearable devices in the context of American football training. The system, built upon a high-efficiency machine learning algorithm optimized for embedded systems, aims to detect and improve spin moves. The system's novelty lies in integrating the wearer's motion data with real-time positional and play data from other players, offering instantaneous, context-aware feedback. The innovative design promises transformative training insights for athletes, providing both performance analysis and real-time guidance.

### FIELD OF THE INVENTION

The present invention relates generally to the field of sports training technology. More specifically, it pertains to a feedback system embedded within wearable devices, optimized for detecting, analyzing, and enhancing spin moves in football using real-time player data.

### BACKGROUND OF THE INVENTION

American Football, a sport steeped in strategy and skill, requires players to execute precise maneuvers in high-pressure situations. Among these maneuvers, the spin move is both iconic and challenging. Perfecting this move demands not just repetition but also feedback—information that tells a player what they're doing right and where they can improve. Traditional training methods, reliant on after-the-fact video analysis or coach feedback, introduce delays that can hamper the learning process. The current invention addresses this gap, introducing real-time, on-the-field feedback for players.

### SUMMARY OF THE INVENTION

The invention presents a feedback system tailored for wearable devices. This system harnesses the power of high-efficiency machine learning algorithms, designed explicitly for embedded systems, to analyze player movements in real-time. The primary objective is to detect and assess the effectiveness of spin moves executed during an American football game or during training.

The novelty of the invention stems from its capability to combine on-device motion data with real-time positional and play signals from other players on the field. This holistic analysis, processed by a highly efficient embedded machine learning model, allows for instantaneous, context-aware feedback to the player. Such feedback can transform training sessions, offering athletes actionable insights as they execute their maneuvers.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

FIG. 1 is a detailed schematic of a wearable device, showing its embedded components, including motion sensors, an embedded processor, various feedback mechanisms, and a communication module.

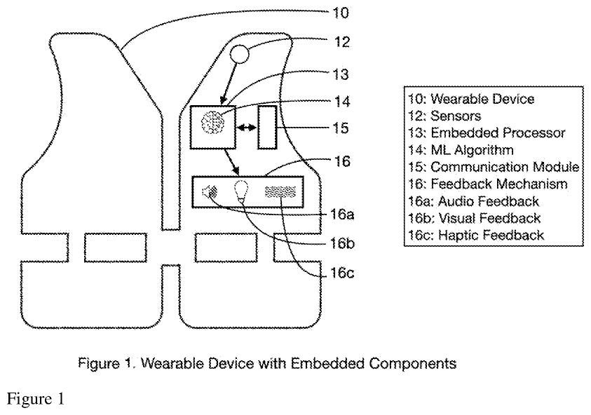

FIG. 2 depicts a system overview highlighting the interaction between the wearable device, the server component, and the real-time data exchange with other players on the football field.

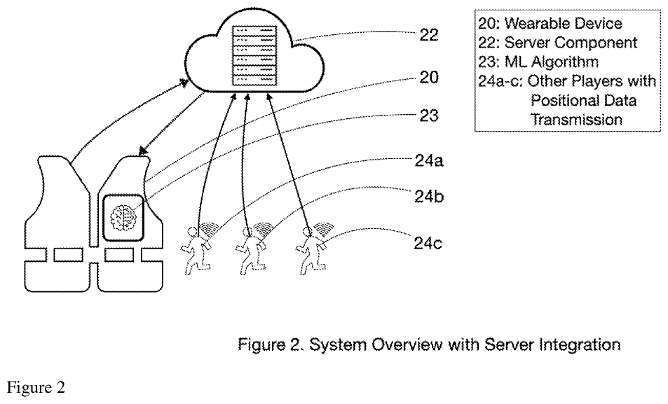

In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

### DETAILED DESCRIPTION OF THE INVENTION

The present invention seeks to address challenges in the realm of real-time sports training and feedback, particularly in the context of football's dynamic maneuvers like spin moves. The landscape of sports technology has witnessed an array of devices and software promising enhancements in training, but most grapple with the balance of efficiency, size, and precision. The heart of the novelty in this invention lies in bridging these gaps.

High-Efficiency Machine Learning Software: At the epicenter of this invention is the development of a groundbreaking machine learning software. Unlike traditional models that often demand significant computational resources, this software distinguishes itself through high efficiency. Designed to function seamlessly in real-time scenarios, it deftly handles a flood of data inputs without compromising on speed or accuracy.

Optimized for Embedded Systems: A significant leap forward is the ability of this machine learning model to operate within the confines of an embedded system. Where many algorithms falter or require pared-down versions to fit into embedded devices, the invention's software maintains a uniquely small memory footprint. This compactness, however, does not detract from its capability. Instead, it ensures that wearable devices remain lightweight and unobtrusive while still housing advanced analytical prowess.

Integration of Real-time Player Data: Another key innovation is the device's ability to integrate live positional and play signals from other players in the field. This dynamic interplay of data is vital in rendering feedback that is contextually relevant. A spin move's effectiveness is not just about the executing player's motion; it's intricately linked to the surrounding players and their actions. By processing this holistic data set in real-time, the invention offers feedback that is both instantaneous and deeply informed.

Effective, Contextual Feedback: With its advanced machine learning core and real-time data integration, the invention goes beyond mere movement analysis. It offers feedback that is attuned to the actual play scenario, guiding the athlete not just based on their individual motion, but also the ongoing play's broader context.

### DETAILED DESCRIPTION OF THE PREFERRED EMBODIMENT

The preferred embodiment of the invention incorporates a two-component structure: the embedded device and the server component. The sensor on the wearable device sends motion data to the motion detection system on the device. Concurrently, the embedded system receives real-time positional and play data from other players on the field via the server component. This combined data feeds into a pre-trained machine learning algorithm optimized for the embedded system. The algorithm's unique design allows it to swiftly determine the effectiveness of a spin move based on real-time game context.

Furthermore, an enhancement in this embodiment offers athletes real-time guidance to adjust their moves for improved effectiveness during play.

1. A system for real-time detection, analysis, and feedback of football spin moves, comprising:
a wearable device configured to be worn by a football player;
one or more motion sensors integrated into said wearable device, said sensors being adapted to capture motion data during play;
an embedded processor housed within said wearable device;
a machine learning algorithm, residing on said embedded processor, specifically trained to: a. analyze said motion data, b. identify instances of spin moves performed by the wearer, and c. evaluate the effectiveness of identified spin moves based on predetermined criteria;
a communication module in said wearable device configured to receive real-time positional and play data from other players on the field;
a feedback mechanism to provide instantaneous feedback to the player regarding the effectiveness of their spin move and potential adjustments.

2. The system of claim 1, wherein said machine learning algorithm is optimized for a minimal memory footprint, allowing for efficient execution on the embedded processor.

3. The system of claim 1, wherein the feedback mechanism includes one or more of: a visual display, audio feedback, and haptic feedback.

4. The system of claim 1, further comprising:
a server component, distinct from said wearable device, adapted to collect, process, and transmit the real-time positional and play data from other players on the field to the wearable device's communication module.

5. The system of claim 4, wherein the machine learning algorithm uses both the motion data from the sensors and the real-time positional and play data from the server component to evaluate the effectiveness of a spin move within the context of ongoing play.

6. The system of claim 1, wherein the wearable device is configured to guide the player in real-time to modify their spin move to enhance its effectiveness during play.
